(19) United States
(12) Patent Application Publication
(10) Pub. No.: US 2006/0159803 A1
(43) Pub. Date: Jul. 20, 2006

(54) Polyol coated particles

(76) Inventors: Thomas V. Gottemoller, Mount Zion, IL (US); Thomas P. Binder, Decatur, IL (US); Allan W. Buck, Decatur, IL (US)

Correspondence Address: KIRKPATRICK & LOCKHART NICHOLSON GRAHAM LLP;HENRY W. OLIVER BUILDING, 535 SMITHFIELD STREET, PITTSBURGH, PA, 15222, US

(21) Appl. No.: 11/323,817

(22) Filed: Dec. 30, 2005

Related U.S. Application Data
(60) Provisional application No. 60/640,898, filed on Dec. 30, 2004.

(51) Int. Cl. A23G 4/18

(52) U.S. Cl. 426/5

(57) ABSTRACT

A microparticle having a calcium moiety encapsulated by a sugar alcohol such as mannitol. The microparticle may be substantially spherically shaped and may be used in conjunction with sugar-free gum compositions. Microparticles comprising a calcium moiety encapsulated by mannitol may be used as a sugar-free sweetener such as a replacement for sucrose or other sweetener in food, beverages, and pharmaceuticals. A confectionery ingredient is also included herein and comprises a calcium moiety encapsulated by a sugar alcohol such as mannitol.

### CROSS-REFERENCE TO RELATED APPLICATIONS

This application claims the benefit of U.S. Provisional Application Ser. No. 60/640,898 filed Dec. 30, 2004, and co-pending U.S. Non-Provisional Application Ser. No. to be assigned that was filed Dec. 29, 2005, both of which are incorporated by reference herein in their entirety.

### FIELD OF THE INVENTION

Provided herein is a composition for an ingredient in food suitable for use as an edible dusting agent, and a sweetening ingredient for confectionery articles.

### BACKGROUND

Confectionery products have traditionally derived their sweetness from sucrose. Sucrose is a disaccharide comprised of glucose and fructose moieties, and is present in processed foods in significant amounts. Because of its abundance in processed foods, many consumers monitor their sucrose intake. Accordingly, a high consumer demand for foods having reduced sucrose content exists.

Chewing gum is a mixture of one or more polymeric materials, usually blended with one or more additional ingredients, such as bulking agents, plasticizers, sweeteners and/or flavorings. The physical properties that make these components effective in a chewing gum also contribute to the difficulty of manufacturing and packaging. For instance, the polymeric material can often become sticky, particularly when the material is heated during the mixing of the various ingredients. The gum can remain quite sticky during rolling of the gum bulk into flat sheets from which sticks of gum are manufactured. Ingredients used as bulking agents, plasticizers, flavorings and/or sweeteners are often sticky as well. Furthermore, many of such ingredients are hygroscopic, absorbing water vapor from the atmosphere, which in turn adds to the stickiness of the chewing gum during its manufacture and packaging.

It is known in the art to employ a dusting agent, also known as dusting powder or rolling powder, to reduce the stickiness of the chewing gum during its manufacture and packaging. Specifically, after the various components are heated and mixed together, the mass of gum is fed through an extruder, which forms it into a continuous sheet. The dusting agent is then deposited on the planar surfaces of this flat sheet before it is fed through a rolling machine, which reduces the thickness of the gum sheet to that of the finished sticks.

The dusting agent inhibits adhesion of the chewing gum to rollers and other equipment with which it comes into contact, which is very useful during commercial manufacturing operations that pass the sheet through associated machinery at many dozens of feet per second. In addition, the dusting agent inhibits adhesion of the gum to the machinery that subsequently cuts the gum into sticks and packages. Dusting agents also inhibit adhesion of the gum to the wrapper with which the gum eventually comes into contact.

Examples of dusting agents and their use are disclosed in, for instance, U.S. Pat. No. 4,208,432; U.S. Pat. No. 5,145,696; U.S. Pat. No. 4,374,858; and U.S. Pat. No. 4,976,972.

In the case of sugar-free gum, one of the most common dusting agents is powdered mannitol. Prior to the introduction of mannitol, starch was used as a dusting agent. Although mannitol costs more than starch, it provides a better taste. Further, mannitol does not promote tooth decay, and is, thus, preferred over starch for use in sugar-free gum.

Mannitol, therefore, is preferred over starch, as consumers of sugar-free gum become more quality conscious.

Powdered mannitol, however, is not as free-flowing as starch. Mannitol is also expensive, thus limiting its use as a dusting agent. Other ingredients have therefore been combined with powdered mannitol to improve its suitability for use in processing equipment. U.S. Pat. No. 4,562,076, issued to Arnold et al., for example, discloses the use of thaumatin or monellin (highly potent sweet proteins) in combination with mannitol, sorbitol, sucrose, starch, calcium carbonate or talc, as a dusting agent.

U.S. Pat. No. 4,988,518, issued to Patel et al., discloses the use of mannitol in combination with a liquid flavoring agent as a dusting agent. U.S. Pat. No. 4,976,972, issued to Patel et al., discloses a dusting agent comprised primarily of xylitol, but also up to 20% by weight of an anti-caking agent, such as fumed or precipitated silica, talc, starch, calcium carbonate, calcium phosphate, and magnesium stearate. A bulking agent, such as sorbitol, mannitol, or hydrogenated isomaltulose, may also be used in the dusting agent. However, the bulking agent is used to simply reduce costs and, as the amount of bulking agent is increased in the mixture, the “benefits of the present invention [are] correspondingly reduced.” See col. 6: lines 23-41 of Patel '972. The compound of Patel is not formed with any specific or required procedure, but may be formed by a number of different known methods, including dry blending or fluidized bed techniques with further grinding by jet milling, turbo milling, hammer milling, roller crushing, or other suitable method. Other additives, including flavors, colors and high-intensity sweeteners, may be added in liquid form or otherwise by known techniques.

U.S. Pat. No. 4,208,432, issued to Noborio et al., discloses a powdery antistick agent for use with chewing gums. The antistick agent is formed of alpha and beta lactoses, calcium carbonate, and mixtures thereof, which are coated with saturated fatty acid monoglycerides, or derivatives thereof. The monoglycerides are comprised of at least twelve carbon atoms and have an acid value of two or less and an iodine value of two or less.

U.S. Pat. No. 4,317,838, issued to Cherukuri et al., discloses coating compositions for confectionery products including a dry coating and a wet coating. The wet coating is added in a syrupy state and is primarily composed of sorbitol. A dusting mix which may include mannitol and calcium carbonate is then added in a dry state. The dusting mix is prepared by simply mixing the various ingredients until a substantially homogeneous mixture is formed. The syrup layer may be added over the dusting layer in a manner that the successive coatings form a coating comprised of many layers. The resulting composite coating is therefore a shell coating, resulting from the hardening of the syrup.

It is also known to combine mannitol with magnesium silicate, which is commonly known as talc. A dusting powder blend of 93% by weight mannitol powder and 7% by weight talc has flow properties suitable for use in production equipment and has been used successfully on a production scale. However, there is a need in industry for dusting powders which contain mannitol but not talc and which have flow properties similar to the blend of 93% by weight mannitol and 7% by weight talc.

Calcium carbonate has also been used as a dusting powder, but it is abrasive and has a crystalline structure that results in poor flowability characteristics. In order to combat this, it is known to coat calcium carbonate with a fat, oil, or wax coating. Such a coating is disclosed in U.S. Pat. No. 5,925,387, issued to Gimmler et al., which is drawn to a wax-coated calcium carbonate surface powder for a chewing gum. A wax coating, however, has adverse taste characteristics which negatively affect the gum and may further contribute to a chewing gum with an undesirable mouth-feel.

There has not yet been provided a dusting agent for a chewing gum composition, such as a sugar-free chewing gum composition, with satisfactory flowability and taste characteristics. It is further desirable to provide a calcium carbonate microparticle which is more rounded (e.g., spherical) and has better flow characteristics. It is still further desirable to provide a non-hygroscopic dusting agent with improved taste characteristics, improved flowability, and a reduced production cost.

Chocolate products are typically mixtures of liquid cocoa, cocoa butter, sucrose, lecithin, and, possibly, milk and flavoring substances. The typical preparation of chocolate involves four stages, mixing/kneading, refining, conching, and tempering. In the first stage, the ingredients are mixed together in a kneading process that also involves refining or grinding, for example, on a multiple roll refiner to provide a smooth, fluid paste. The ingredients may be added sequentially and, in particular, the cocoa butter may be added step-wise to control the viscosity of the composition. The sugar may also be pre-ground to a smaller particle size to reduce the length of time required in the kneading and refining of the chocolate mixture. The paste resulting from kneading should have a specific texture that is appropriate for the subsequent refining operation. It is possible to control the texture by adjusting the particle size of the sugar, the fat content, and/or the emulsifiers.

Most chocolate is subjected to the process of conching, in which the chocolate mixture is subjected to mechanical working to give the chocolate a fuller and more homogeneous flavor. Other ingredients, such as flavorings, such as, for example, vanilla and extra cocoa butter, may be added at this stage if desired. A frequently added additional ingredient is lecithin or other emulsifier which improves the flow properties of the chocolate and thereby enables the amount of cocoa butter to be reduced. The third stage of the chocolate preparation is called tempering, in which the liquid chocolate composition is cooled to a temperature below its solidification temperature and then reheated in order to form the proper fat crystal structure. The final appearance of the chocolate, its texture and keeping properties depend upon correct tempering stage conditions. After tempering, the chocolate may finally be cast into molds to set or may be used in an enrobing process to produce chocolate-coated confectionery, etc.

At all stages of preparation, it is important to control the viscosity of the chocolate composition in order to achieve the desired texture characteristics of the finished product and ensure proper workability of the composition. Viscosity can be controlled by adjusting the amount of cocoa butter in the composition.

Conventional chocolate compositions use sucrose as a sweetener. However, other sweeteners can be used, especially for dietetic chocolate for diabetics and dieters. Sugar alcohols are one class of replacement sweeteners for sucrose. Sugar alcohols include, for example, mannitol, sorbitol, xylitol, maltitol, isomalt, erythritol, glycerol, lactitol and hydrogenated starch hydrolysate. Sugar alcohols, besides contributing fewer calories to the chocolate than the equivalent quantity of sucrose, are also not cariogenic.

Sugar alcohol sweeteners such as mannitol have been used as a substitute for sucrose, but sugar alcohols can have several drawbacks, which makes them unsuitable for use in chocolate. For example, granulated and/or powdered mannitol has a tendency to absorb cocoa butter in a chocolate composition, which increases viscosity and results in a product that is less workable, mixes poorly, and is difficult to shape. If additional cocoa butter is added to reduce the viscosity, the resulting product has poor taste and texture. Thus, there is a need for a sucrose substitute in a chocolate composition that does not decrement the rheological properties of the chocolate. It is also desirable to provide a sugar-free ingredient in a chocolate composition which has desirable taste characteristics. It is further desirable to use mannitol to replace sucrose in chocolate, wherein the mannitol ingredient does not absorb the cocoa butter to an extent that the taste and texture of the chocolate composition are compromised.

### SUMMARY OF THE INVENTION

Provided herein is a microparticle composition which can be used as a dusting agent and as an ingredient in a confectionery. The ingredient of the invention comprises a calcium moiety encapsulated by a coating of a sugar alcohol, such as mannitol. The ingredient may also be substantially spherically shaped. Calcium moieties finding particular use in the compositions and methods of the invention include calcium carbonate, calcium sulfate, calcium lactate, calcium citrate, and other calcium moieties. In a non-limiting embodiment, the ingredient may be used to manufacture a confectionery, such as a gum composition and chocolate. In another non-limiting embodiment, the ingredient may be used to manufacture a confectionery that is sugar-free.

According to another aspect of the present invention, the compositions of the invention may be used to coat a confectionery, wherein the coating comprises a compound, including a calcium moiety, and wherein the compound is coated by mannitol, and further wherein the edible dusting agent is substantially spherically shaped.

According to yet another aspect of the present invention, compositions of the invention include microparticles that comprise a compound including a calcium moiety, and wherein the microparticles are coated by mannitol. In a non-limiting embodiment, about 90% by weight of the microparticles are less than 150 microns in diameter. In a further non-limiting embodiment, about 80% by weight of the microparticles are less than 75 microns in diameter.

In another aspect of the present invention, a sweetener for a sugar-free chocolate composition is provided, the sweetener comprising a compound, including a calcium moiety, the compound being coated by mannitol.

An additional aspect of the present invention is directed to a method of making a sugar-free confectionery ingredient. The method comprises mixing ingredients, including a compound including calcium moieties with liquid mannitol, to form a suspension of the calcium moiety in mannitol. The suspension is dried to form discrete microparticles comprising the calcium moiety coated with mannitol.

Yet an additional aspect of the present invention provides a confectionery ingredient comprising a compound, including a calcium moiety that is coated by mannitol. The ingredient of the present invention may further include water or moisture in the form of condensation within the ingredient.

It should be understood that this invention is not limited to the embodiments disclosed in this summary, and is intended to cover modifications that are within the spirit and scope of the invention, as defined by the claims.

### BRIEF DESCRIPTION OF THE DRAWINGS

FIG. 1 is a scanning electron micrograph of raw calcium carbonate at one hundred times magnification.

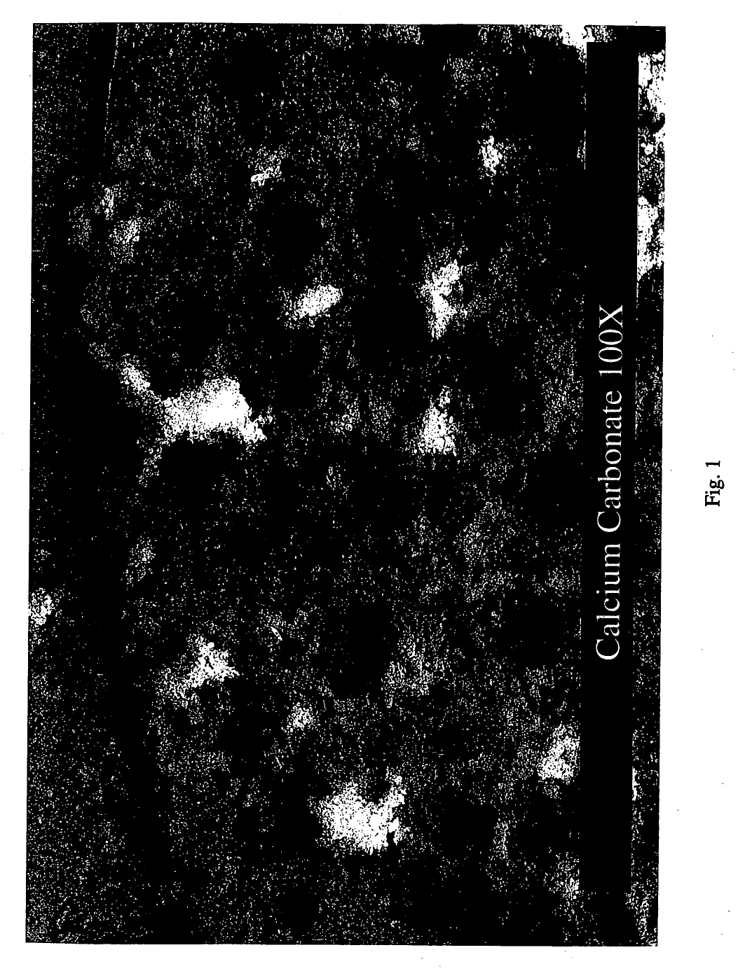

FIG. 2 is a scanning electron micrograph of raw calcium carbonate at five hundred times magnification.

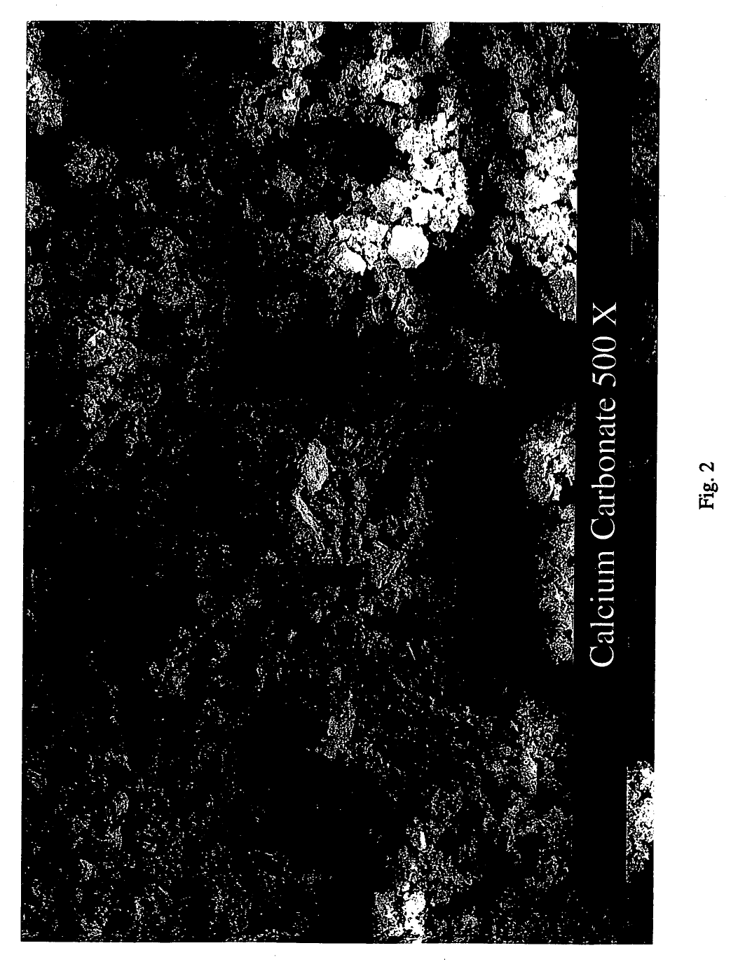

FIG. 3 is a scanning electron micrograph of raw calcium carbonate at one thousand times magnification.

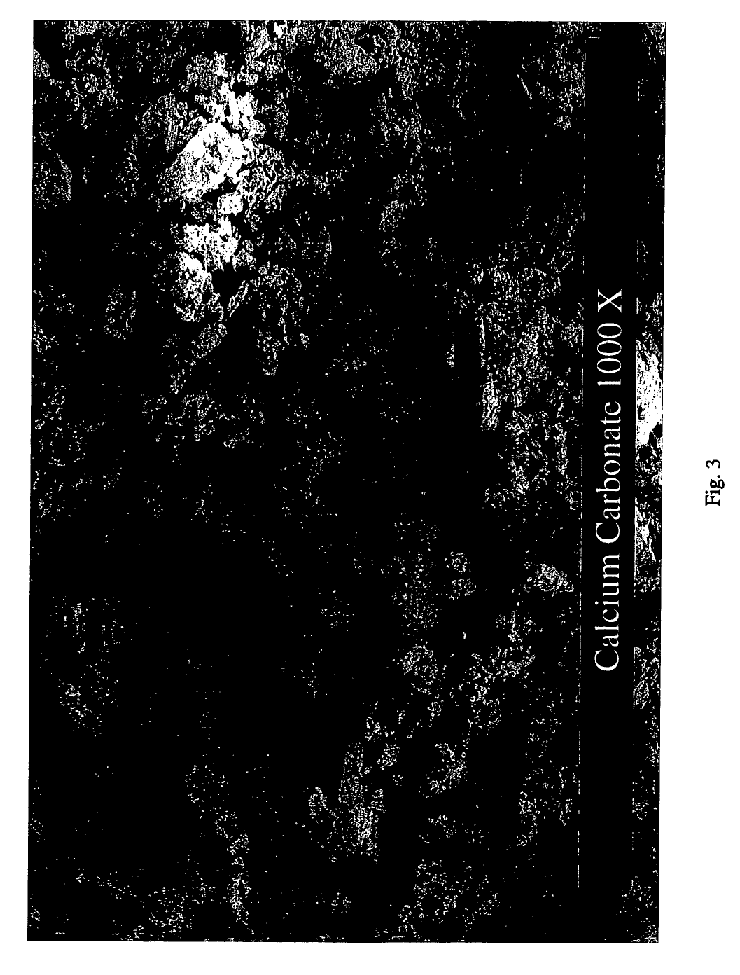

FIG. 4 is a scanning electron micrograph of mannitol coated calcium carbonate at one hundred times magnification.

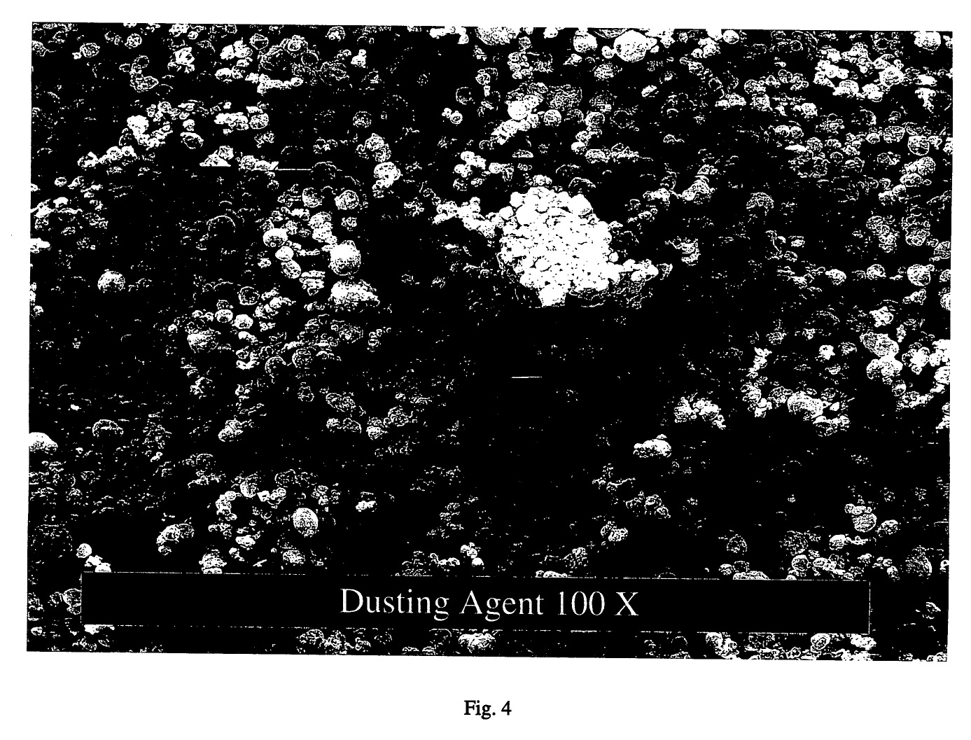

FIG. 5 is a scanning electron micrograph of mannitol coated calcium carbonate at five hundred times magnification.

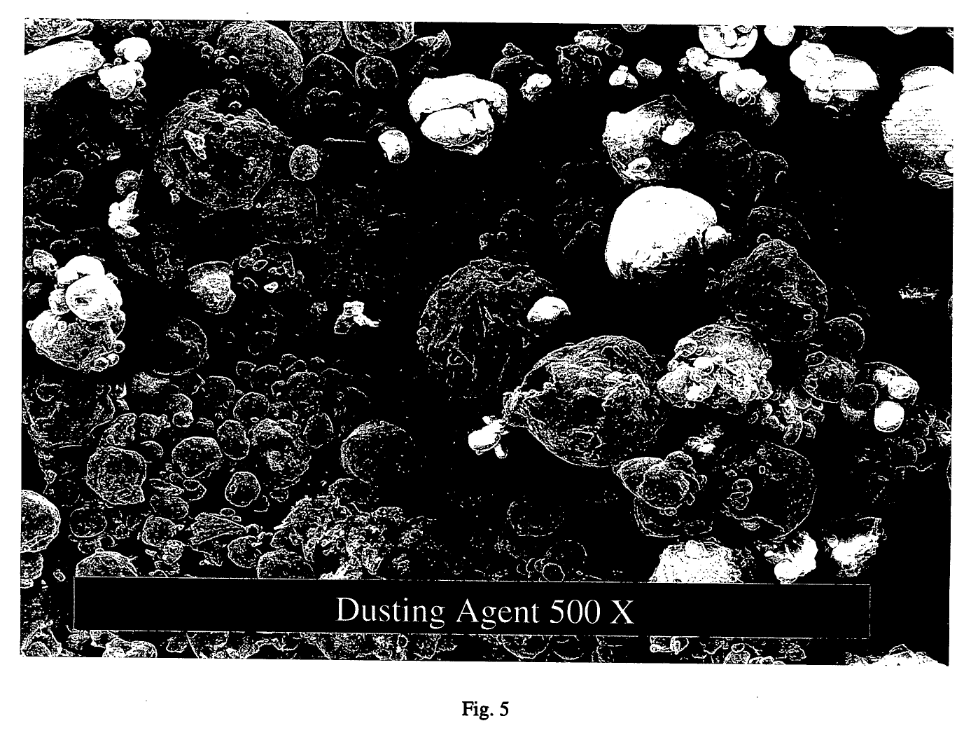

FIG. 6 is a scanning electron micrograph of mannitol coated calcium carbonate at one thousand times magnification.

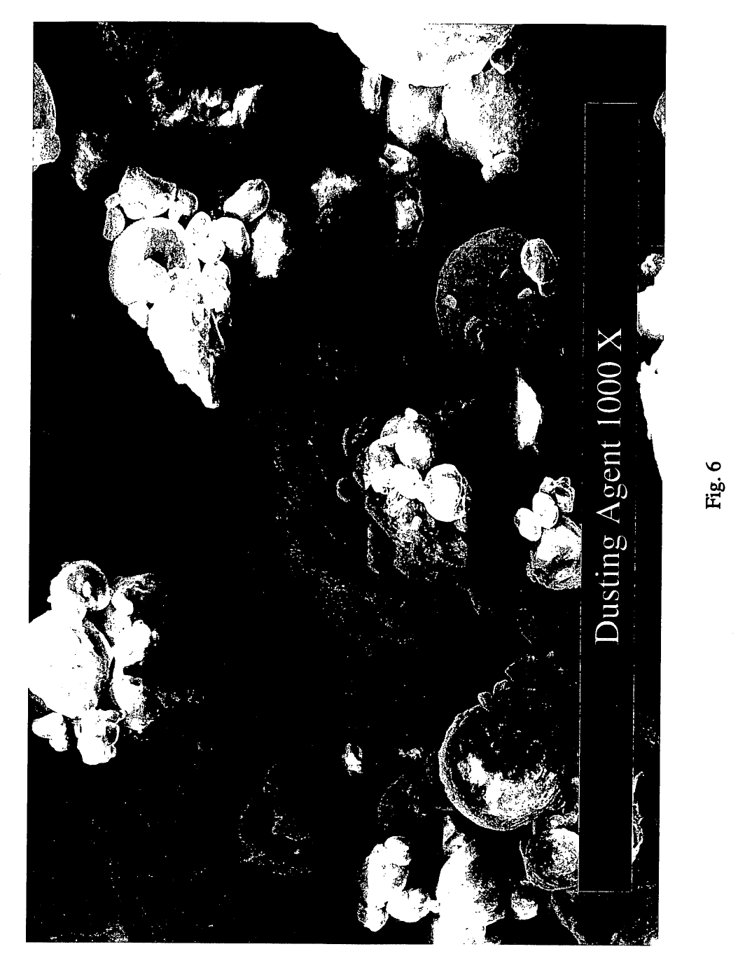

FIG. 7 is a plot of the flowability of screened mannitol coated calcium carbonate as quantified by the mean time to avalanche using an AERO-FLOW™ powder flowability analyzer (TSI Inc., Shoreview, MN).

FIG. 8 is a plot of the flowability of unscreened mannitol coated calcium carbonate as quantified by the mean time to avalanche using an AERO-FLOW™ powder flowability analyzer (TSI Inc., Shoreview, MN).

FIG. 9 is a plot of the flowability of screened calcium carbonate as quantified by the mean time to avalanche using an AERO-FLOW™ powder flowability analyzer (TSI Inc., Shoreview, MN).

FIG. 10 is a plot of the flowability of unscreened calcium carbonate as quantified by the mean time to avalanche using an AERO-FLOW™ powder flowability analyzer (TSI Inc., Shoreview, MN).

### DETAILED DESCRIPTION OF THE INVENTION

It is to be understood that certain descriptions of the present invention have been simplified to illustrate only those elements and limitations that are relevant to a clear understanding of the present invention, while eliminating, for purposes of clarity, other elements. Those of ordinary skill in the art, upon considering the present description of the invention, will recognize that other elements and/or limitations may be desirable in order to implement the present invention. However, because such other elements and/or limitations may be readily ascertained by one of ordinary skill upon considering the present description of the invention, and are not necessary for a complete understanding of the present invention, a discussion of such elements and limitations is not provided herein. As such, it is to be understood that the description set forth herein is merely exemplary to the present invention and is not intended to limit the scope of the claims.

Furthermore, certain compositions within the present invention are generally described in the form of ingredients that may be used to produce food products, such as confectioneries, and other foods. As used herein, the term “confection” is intended to mean any type of manufactured product that is intended for human consumption and comprises multiple ingredients. The term “confectionery” is intended to mean a food that has a sweet flavor and/or aroma, and includes but is not limited to preserves, jellies, cakes, cookies, pastries, candies, chocolates, fudge, gums including chewing gum, mints, sweetened snack foods, etc. It will be understood, however, that the present invention may be embodied in forms and applied to end uses that are not specifically and expressly described herein. For example, one skilled in the art will appreciate that embodiments of the present invention may be incorporated into any food.

Other than in the examples herein, or unless otherwise expressly specified, all of the numerical ranges, amounts, values and percentages, such as those for amounts of materials, elemental contents, times and temperatures of reaction, ratios of amounts, and others, in the following portion of the specification and attached claims may be read as if prefaced by the word “about”, even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (i.e., end points may be used). When percentages by weight are used herein, the numerical values reported are relative to the total mass weight. Those of skill in the art recognize that percent mass weight and actual mass weight are interconvertable.

All referenced patents, patent applications, publications, or other disclosure material are incorporated by reference in whole but only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. The articles “a,” “an,” and “the” are used herein to refer to one or more than one (i.e., to at least one) of the grammatical object of the article. By way of example, “an element” means one or more elements, and thus, possibly, more than one element is contemplated, and may be employed or used.

The invention, as described herein, encompasses microparticles comprising a calcium moiety, such as a calcium salt, coated with sugar alcohol. As used herein, the term “coat(ing)” is intended to mean that the substance of interest is deposited on, but not necessarily adjacent to, a portion of, and in some embodiments substantially all of, the surface of a particle or microparticle. Where the coating forms a hard shell around at least a portion of the particle or microparticle, and in some embodiments around substantially the entirety of the particle, the particle is thereby said to be “encapsulated.” The term “encapsulated” is intended to encompass coatings that are dried, i.e., where at least some of the water in the coating is removed. For example, in one embodiment, a calcium salt, such as calcium sulfate, calcium carbonate, or other suitable calcium salt, is coated with a sugar alcohol, such as mannitol, and then dried using, for example, a spray dryer to form an encapsulated microparticle. Compositions and confectionery products having the ingredient of the invention can have reduced carbohydrate content as compared to products containing sucrose or other nutritive or nonnutritive sugars. Thus, the microparticles of the invention are useful as a food additive, including but not limited to use as an additive for sugar-free chewing gum (e.g., as a dusting agent or rolling compound), use as a sugar-free cereal coating, and use as a nutritive sweetener in dietetic food, such as low-carbohydrate foods and confectioneries (e.g., sugar-free chocolate). Further, in some embodiments of the invention, the microparticles are free-flowing. And, in yet other embodiments, the microparticles are non-hygroscopic.

The term “sugar” refers to any molecule comprising a moiety with the chemical formula of (CH₂O)ₙ. Sugars of use in the invention may comprise any carbon length, and include sugars with 4, 5, 6, 7 or more carbon atoms (i.e., tetroses, pentoses, hexoses, heptoses, etc.). Examples of sugars include monosaccharides (e.g., fructose, mannose, and glucose) and disaccharides (e.g., sucrose, lactose, and maltose), as well as oligo- and polysaccharides, and mixtures thereof (e.g., corn syrup solids). Sugars may be used in any form, including sugar crystals. Further, as is known in the art, sugars such as pentoses and hexoses are not generally found as open-chain molecules, but as cyclic molecules. Thus, the term “sugar” encompasses any open-chain sugars, cyclic sugars, and combinations thereof.

Some sugars can be hydrogenated to form sugar alcohols, which are a class of polyols. Polyols have the general formula CH₂OH(CHOH)ₙCH₂OH. It is contemplated that the polyols of the present invention include two or more of these units, thus comprising an oligomeric or polymeric chain of the single units. Many sugar alcohols have a sweet taste and, therefore, may be used as a sugar substitute in food and beverages. As used herein, the term “sugar alcohol” is intended to mean a compound comprising a moiety having a hydrogenated form of carbohydrate, whose carbonyl group (aldehyde or ketone, reducing sugar) has been reduced to a primary or secondary hydroxyl group. For example, dextrose in its alcohol form is sorbitol; maltose in its alcohol form is maltitol; mannose in alcohol form is termed mannitol, while fructose as an alcohol can form mannitol and sorbitol; xylose in its alcohol form is xylitol. The term “sugar alcohol” also encompasses mixtures of sugar alcohols, including, for example, hydrogenated starch hydrolysates. Thus, the term “sugar alcohol” encompasses sugar alcohols useful as sweeteners and includes, for example, mannitol, sorbitol, xylitol, maltitol, isomalt, erythritol, glycerol, lactitol, hydrogenated starch hydrolysate, and their mixtures. The term “mannitol,” as used herein, refers to the straight-chain hexahydric alcohol of the formula C₆H₈(OH)₆. Mannitol is typically a white, crystalline powder, granular at room temperature, is soluble in water, slightly soluble in lower alcohols and amines and almost insoluble in other organic solvents. The term “sugar-free” as used herein refers to foodstuffs and/or ingredients within foodstuffs which are substantially free of the sugar sucrose.

The term “microparticle” refers to a particle having an average diameter of less than 30 mesh (i.e., 595 microns). In some embodiments of the invention, the average diameter of the microparticles is less than 35 mesh (i.e., 500 microns), less than 40 mesh (i.e., 400 microns), less than 45 mesh (i.e., 354 microns), less than 50 mesh (i.e., 297 microns), less than 60 mesh (i.e., 250 microns), less than 70 mesh (i.e., 210 microns), less than 80 mesh (i.e., 177 microns), less than 100 mesh (i.e., 149 microns), less than 120 mesh (i.e., 125 microns), less than 140 mesh (i.e., 105 microns), less than 170 mesh (i.e., 88 microns), less than 200 mesh (i.e., 74 microns), less than 230 mesh (i.e., 62 microns), less than 270 mesh (i.e., 53 microns), less than 325 mesh (i.e., 44 microns), less than 400 mesh (i.e., 37 microns), or less. A range of diameters for the microparticles described herein find use in the invention. For example, in one embodiment, the microparticles have a size range from between 10 and 800 microns. In another embodiment, the microparticles have a size range from between 30 and 400 microns. In yet other embodiments, the size range of the microparticle may be between 40 and 390 microns, between 50 and 380 microns, between 60 and 370 microns, between 70 and 360 microns, between 80 and 350 microns, between 90 and 340 microns, between 100 and 330 microns, between 110 and 320 microns, between 120 and 310 microns, between 130 and 300 microns, between 140 and 290 microns, between 150 and 280 microns, between 160 and 270 microns, between 170 and 260 microns, between 180 and 250 microns, between 190 and 240 microns, between 200 and 230 microns, etc. The term “powder” as used herein, is intended to mean a collection of particles, without limitation as to size, sphericity, flowability, or any other physical property of any constituents comprising the powder.

Microparticles of the invention may be any shape, including rounded. The term “rounded”, as used herein, refers to a particulate with a substantially non-angular surface and may comprise particles that are spherical or substantially spherical. The term “substantially spherically shaped,” or “spherically shaped,” as used herein, refers to a microparticle wherein greater than 70%, 80% or 90% or more of the surface of the particle is a non-angular (i.e., rounded) surface. Sphericity can be measured in using a Beckman-Coulter RAPIDVUE® bench top particle shape and size analyzer. In some embodiments, mannitol coated calcium carbonate has an average sphericity of 0.80, with 1.0 being a perfect sphere. Thus, in some embodiments, the microparticles have a sphericity of greater than 0.7, greater than 0.8, or greater than 0.9. In yet other embodiments, the sphericity of the microparticles is between 0.7 and 1.0, 0.8 and 1.0, or 0.9 and 1.0. Aerosol techniques can be used to create substantially spherical microparticles. For example, in droplet-to-particle processes such as spray drying methods (e.g., atomization), the solution is aerosolized and then dried, thereby yielding spherical particles. Such rounded surfaces can convey advantageous properties to microparticles such as improving the bulk flow characteristics.

The sensitivity of a powder (i.e., dry composition of microparticles) to flow rate may be expressed as a flow rate index calculated as follows:

$$Flow Rate Flowability Index = \frac{Energy consumed at 10 mm \text{/} s blade tipspeed}{Energy consumed at 100 mm \text{/} s blade tipspeed}$$

High values are characteristic of cohesive powders and indicate potential processing difficulties, especially if combined with other adverse characteristics such as a high-compaction flowability index. Some powders behave as Newtonian fluids and require less energy at lower flow rates. In these cases, the flow rate index is less than one. Flowability is particularly important in applications requiring use of the microparticles as dusting agents. For example, calcium carbonate microparticles in a raw state have a surface area that is angular (not rounded), thereby impeding their flowability and, thus, their utility as a dusting agent.

Additionally, the flowability of a powder can be measured using an AERO-FLOW™ powder flowability analyzer (TSI Inc., Shoreview, MN). The instrument contains a rotating drum filled with the test material. A photoelectric eye measures the frequency at which the material rises up the rotating drum and then cascades down, which are termed avalanches. Specifically, the powder sample is placed inside a cavity disk which is inserted into the flowability analyzer. During operation, the disk slowly rotates, while the powder rotates with it, building up to an unstable condition until an avalanche occurs. The avalanche is then detected and measured photoelectrically. Each series of avalanches is analyzed to determine the time to avalanche, a function of the powder's flowability. Free flowing powders will exhibit a shorter time to avalanche than less flowable powders.

Results are plotted on a discrete phase space map. The data is plotted by defining a point by the time between one set of subsequent avalanches and the time between the next set of subsequent avalanches. Thus, in a data set containing the time between avalanches (T1, T2, T3, T4 . . . ), the first point would be described by (T1, T2), the second point would be described by (T2, T3), the nth point would be described by (Tn, Tn+1). Each point is connected to the next point by a line. The resultant graph lies along a forty-five degree axis. The flowability of the powder is quantified by the mean time to avalanche. Free flowing powders will produce a shorter mean time (centroid closer to zero) and less free flowing powders will have a longer mean time (centroid further from zero). Scatter provides an index of the powder's cohesivity. Cohesive powders will exhibit more chaotic behavior, producing a large scatter value. Less cohesive powders are more consistent in their behavior and will have smaller scatter values.

The term “dusting agent” or “dusting powder” as used herein refers to particulates used in the production and/or packaging of confectioneries. Dusting agents are used with tacky or sticky confectioneries which require a dusting powder to ease production and packaging thereof. Confectioneries with which a dusting agent or dusting powder may be used include, but are not limited to, chewing gum compositions.

The terms “filler,” “filler particulate”, or “filler agent” as used herein refer to a composition used in lieu of, or in conjunction with, at least one other ingredient in a food, beverage, or pharmaceutical. For example, a filler agent may be used in conjunction with, or in lieu of, a sweetener. The primary utility of the filler agent is to reduce the quantity used of an ingredient during the manufacture of a product. Use of such filler agents can provide any number of advantageous properties to a manufactured product, such as a pharmaceutical, food, or beverages, including, but not limited to, reducing manufacturing costs, reducing the total calories, and providing a health benefit. For example, in an embodiment of the invention, compositions of the invention can be used to provide dietary calcium.

Thus, in some embodiments, microparticles of the invention may comprise a calcium moiety, such as a calcium salt. Calcium salts include, but are not limited to, calcium carbonate, calcium sulfate, calcium citrate, calcium lactate, and combinations thereof. Microparticles comprising calcium-containing moieties may be used as filler for confectionery ingredients, such as sweeteners or as a dusting agent contemplated in the present embodiments. In one embodiment, the calcium-containing moiety may be calcium carbonate, which has a molecular formula of CaCO₃, and is typically a white powder or colorless crystal that is odorless and tasteless and sparingly soluble in water. Calcium carbonate in powder form is characterized by irregularly shaped and angular microparticles, which do not flow readily when assembled collectively as a powder. Calcium sulfate, which also may be used in the compositions of the invention has a molecular formula of CaSO₄ and is typically found as a white, odorless powder or in crystalline form. Calcium sulfate is slightly soluble in water.

In yet other embodiments, the calcium salt may be coated with a sugar alcohol such as mannitol. Such microparticles comprising calcium moieties may be used as a filler agent or a dusting agent. It has been surprisingly discovered that coating calcium moieties with mannitol improves the flow characteristics of such microparticles. For example, without being bound by any mechanism or theory of action, it is noted that such a coating reduces the angularity of the surface of the microparticles of calcium carbonate, which helps to improve the flow characteristics of the composition, while preventing the calcium carbonate from absorbing moisture and thereby reducing flow characteristics due to hygroscopic water in the composition. As described herein, an ingredient of the invention may be in the form of a microparticle. The ingredients of the invention may be any shape, but in some embodiments the ingredient may be rounded and, in yet further embodiments, substantially spherically or spherically shaped.

In a non-limiting embodiment, calcium salts, such as calcium carbonate, calcium sulfate, calcium citrate, and calcium lactate, may be used as a filler. The term “filler” is intended to mean an ingredient that acts as a substituent for another ingredient. The filler may be used to ameliorate the expense of production while not deleteriously affecting the product. Further, such filler may be used as a source of dietary calcium. Calcium has well-known health benefits, including the promotion and maintenance of bone strength, and it is important to maintain a balanced level of calcium in the bloodstream.

According to one aspect of the present invention, the ingredient of the invention comprises from about 50% to about 75% mannitol by weight (wt.), from about 25% to about 45% calcium carbonate by wt., and from about 1% to about 3% water by wt. In a further non-limiting embodiment, the ingredient may comprise from about 55% to about 70% by wt. of mannitol, from about 30% to about 40% by wt. of calcium carbonate, and from about 1.5% to about 2.5% by wt. of water. In an additional non-limiting embodiment, the ingredient of the present invention may comprise from about 60% to about 65% by wt. of mannitol, from about 32.5% to about 37.5% by wt. of calcium carbonate, and about 2% by wt. of water.

In another non-limiting embodiment, the ingredient of the invention includes from about 50% to about 75% mannitol by wt., from about 25% to about 45% calcium carbonate by wt., and from about 1% to about 3% water by wt. In a further non-limiting embodiment, the ingredient may comprise from about 55% to about 70% by wt. of mannitol, from about 30% to about 40% by wt. of calcium carbonate, and from about 1.5% to about 2.5% by wt. of water. In an additional non-limiting embodiment, the ingredient of the present invention may comprise from about 60% to about 65% by wt. of mannitol, from about 32.5% to about 37.5% by wt. of calcium carbonate, and about 2% by wt. of water.

According to a further aspect of the present invention, the ingredient of the invention is used as a sweetener for a sugar-free chocolate composition. The ingredient may comprise water in the form of condensation or moisture, and further comprise from about 50% to about 75% mannitol by wt., from about 25% to about 45% calcium carbonate by wt., and from about 1% to about 3% water by wt. In one embodiment, the ingredient may comprise from about 55% to about 70% by wt. of mannitol, from about 30% to about 40% by wt. of calcium carbonate, and from about 1.5% to about 2.5% by wt. of water.

In another non-limiting embodiment, the ingredient of the invention comprises from about 50% to about 75% mannitol by wt., from about 25% to about 45% calcium carbonate by wt., and from about 1% to about 3% water by wt. In an additional non-limiting embodiment, the edible dusting agent comprises from about 55% to about 70% mannitol by wt., from about 30% to about 40% calcium carbonate by wt., and from about 1.5% to about 2.5% water by wt. In a further non-limiting embodiment, the edible dusting agent comprises from about 60% to about 65% mannitol by wt., from about 32.5% to about 37.5% calcium carbonate by wt., and about 2% water by wt. Such an ingredient of the invention may be formed into a microparticle by any means known in the art.

A method of making a confectionery is also provided herein. The microparticles manufactured by the process of the invention may be used as a dusting agent or a sweetener for a confectionery, such as, but not limited to, a sugar-free chocolate composition. The method of making the microparticles comprises mixing microparticles comprising a calcium moiety with a liquid sugar alcohol (e.g., liquid mannitol) to form a suspension (e.g., such that the microparticles are coated with the liquid sugar alcohol), and thereafter drying the suspension to form discrete microparticles comprising a calcium moiety encapsulated within a sugar alcohol. As used herein, the term “discrete” is intended to mean that the particles can be separated by mechanical means, and although perhaps adherent to each other in certain embodiments, the particles can be separated using simple mechanical methods, such as agitation and aeration. The drying may be accomplished by any means known in the art, including, but not limited to, flash drying, drum drying, and spray drying the suspension to drive substantially all (>95%) of the moisture content out of the sugar alcohol. In an embodiment, the calcium moiety comprises calcium salts, which include, but are not limited to, calcium carbonate, calcium sulfate, calcium lactate, calcium citrate, and combinations thereof. In a further embodiment, the microparticles further comprise at least some water. Such water may be present in the form of moisture condensation.

In yet an additional embodiment, the compositions of the invention may be produced at a first geographic location and transported or shipped to a second geographic location. For instance, a facility at the first geographic location may be able to produce a product more economically than a facility at the second location due to various factors. The factors may include, inter alia, lower costs of materials (i.e., the mannitol), lower costs of energy (i.e., electricity or gas), lower costs of labor (i.e., wages paid to employees), lower costs of environmental controls or effects, or any other requirement for production of the compositions of the invention. Further, a certain product may be well suited for production in the first geographic location and desired, but not produced well, in the second geographic location. As a non-limiting example, residents of Alaska may desire bananas produced in Central America. Thus, the costs of producing the products in a first geographic location may be less than the costs of producing the products in a second geographic location, resulting in the production costs of the product being less in the first geographic location.

In such an instance, the compositions of the invention may be produced at the first geographic location and shipped to the second geographic location, such as by transport over water with ships or barges, trucking, flying, or other means of transportation. The geographic location may be a county, a state, a country, a continent and/or combinations of any thereof. In this manner, the product may be produced in a first country and transported and/or sold in a second country.

The following are examples of methods and compositions of the invention. The examples are not meant to limit the scope of the invention, as defined by the claims.

### EXAMPLE

4.55 kg. of mannitol and 3.03 kg. of calcium carbonate were mixed together with 3 gallons of water by a GROEN™ mixer (DI Food Services, Jackson, MS) to form a slurry. The mixing was accompanied by heating the mixture to 180° F. The slurry was spray-dried with a tall form dryer with an inlet temperature of 180° F. and an outlet temperature of 450° F. to form individual spherically-shaped microparticles of calcium carbonate encapsulated by mannitol. Ninety-four percent of the microparticles by weight passed (i.e., screened) through a U.S. standard 100 mesh sieve, and eighty-two percent by weight of the microparticles passed through a U.S. standard 200 mesh sieve. In one example, approximately 90% of the particles were smaller than 74 microns.

Particles were further analyzed using a Beckman-Coulter RAPIDVUE® bench top particle shape and size analyzer. The size distribution and sphericity of the sample is shown in Table 1. Mannitol coated calcium carbonate had an average sphericity of 0.80, with 1.0 being a perfect sphere. The particle size of uncoated calcium carbonate was too small to measure in the instrument.

TABLE 1
SAMPLE ANALYSIS SUMMARY (sizes in microns)
EQUIVALENT CIRCULAR AREA DIAMETER

| Count | 114616 | Number percentiles: | | Area percentiles: | | Volume percentiles: | |
|---|---|---|---|---|---|---|---|
| Minimum | 21.4 | 10% | 24.5 | 10% | 35.8 | 10% | 46.1 |
| Maximum | 309.3 | 25% | 30.5 | 25% | 50.4 | 25% | 62.7 |
| D1,0 | 49.0 | 50% | 43.4 | 50% | 69.5 | 50% | 80.9 |
| D3,2 | 71.6 | 75% | 63.0 | 75% | 89.7 | 75% | 100.4 |
| D4,3 | 82.8 | 90% | 82.2 | 90% | 108.0 | 90% | 119.1 |
| | | Std. dev. | 23.18 | Std. dev. | 28.32 | Std. dev. | 30.55 |
| | | | | | | Total volume (cu mm) | 1.26E+01 |

SPHERICITY

| Count | 153819 | Number percentiles: | |
|---|---|---|---|
| Minimum | 0.60 | 10% | 0.70 |
| Maximum | 1.00 | 25% | 0.75 |
| D1,0 | 0.80 | 50% | 0.79 |
| | | 75% | 0.86 |
| | | 90% | 0.90 |
| | | Std. dev. | 0.07 |

Additionally, the flowability of the mannitol coated calcium carbonate was measured using an AERO-FLOW™ powder flowability analyzer (TSI Inc., Shoreview, MN) and compared with the flowability of uncoated calcium carbonate. The more avalanches per unit time, the better the flow properties of the material. In experiments shown in Tables 2-5, the unscreened mannitol coated calcium carbonate had a mean of 2.5 avalanches per second compared with 4.11 for unscreened calcium carbonate, while screened mannitol coated calcium carbonate had a mean of 2.8 avalanches per second versus 4.47 for screened calcium carbonate. Of significance was the improvement in flow properties of the compositions of the invention versus calcium carbonate.

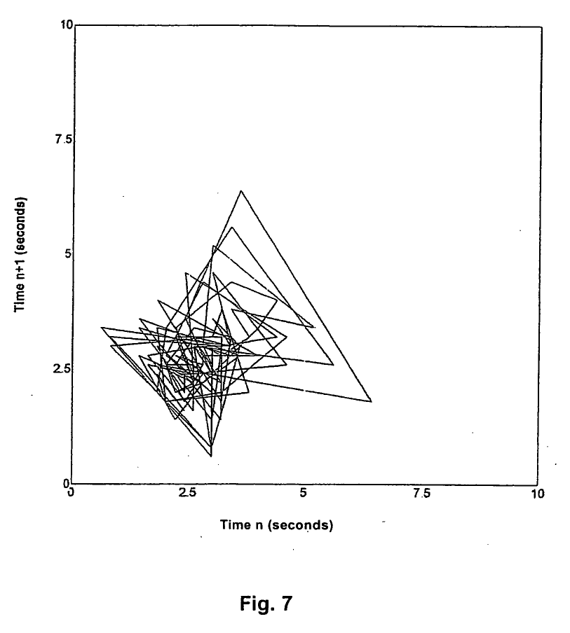

FIG. 7 shows a plot of the flowability of screened mannitol coated calcium carbonate. The physical parameters measured in the corresponding experiment are shown in Table 2.

TABLE 2

Avalanche Range: 0 to 104
Number of Avalanches: 105
Time Between Avalanches
Mean: 2.8 seconds
Scatter: 0.914 seconds
Maximum: 6.4 seconds

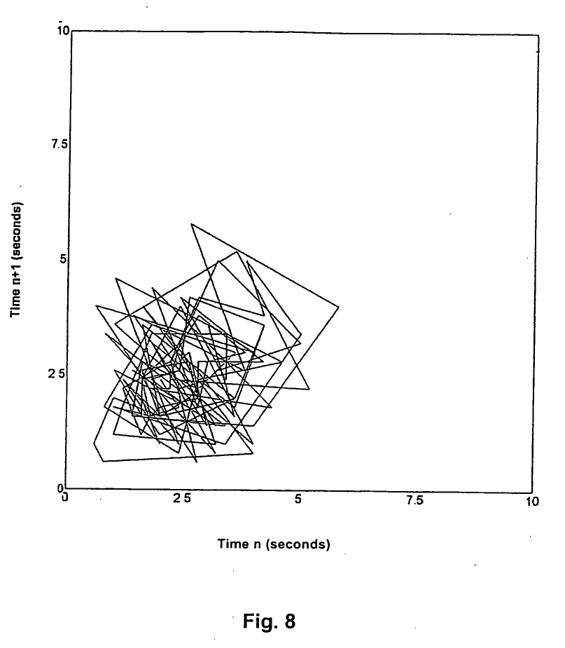

FIG. 8 shows a plot of the flowability of unscreened mannitol coated calcium carbonate. The physical parameters measured in the corresponding experiment are shown in Table 3.

TABLE 3

Avalanche Range: 0 to 117
Number of Avalanches: 118
Time Between Avalanches
Mean: 2.5 seconds
Scatter: 1.08 seconds
Maximum: 5.8 seconds

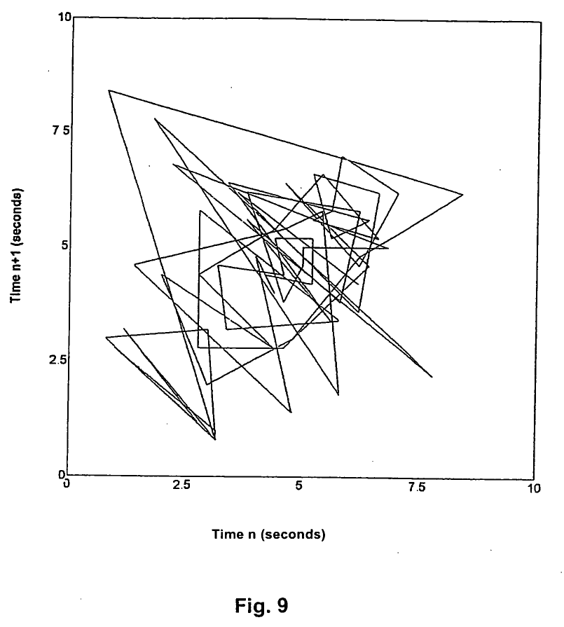

FIG. 9 shows a plot of the flowability of unscreened mannitol coated calcium carbonate. The physical parameters measured in the corresponding experiment are shown in Table 4.

TABLE 4

Avalanche Range: 0 to 65
Number of Avalanches: 66
Time Between Avalanches
Mean: 4.47 seconds
Scatter: 1.72 seconds
Maximum: 8.4 seconds

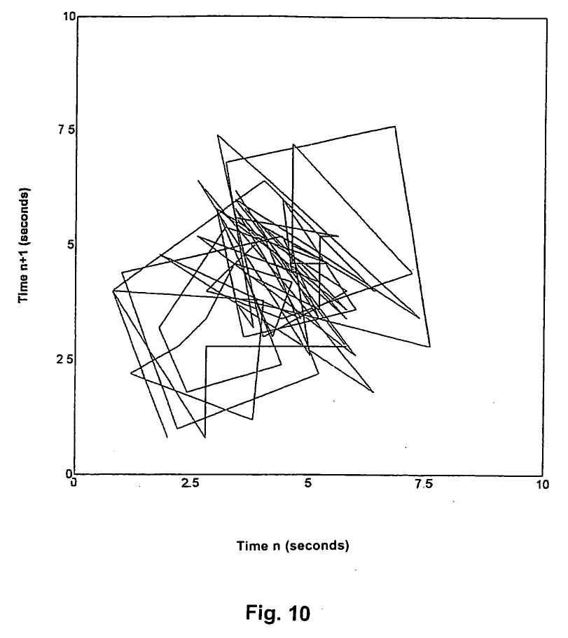

FIG. 10 shows a plot of the flowability of unscreened mannitol coated calcium carbonate. The physical parameters measured in the corresponding experiment are shown in Table 5.

TABLE 5

Avalanche Range: 0 to 72
Number of Avalanches: 73
Time Between Avalanches
Mean: 4.11 seconds
Scatter: 1.57 seconds
Maximum: 7.6 seconds

As disclosed in the example, the present invention provides polyol-coated microparticles. Such microparticles can comprise a calcium moiety such as calcium carbonate. The microparticles of the invention exhibit desirable physical characteristics, such as improved flowability relative to uncoated particles, due, in part, to a coating with a sugar alcohol such as mannitol. Thus, encapsulation of the microparticles with mannitol provides a dusting powder or food additive that may provide added benefits to existing industrial processes and applications.

It will be appreciated by those skilled in the art that changes could be made to the embodiments described herein without departing from the broad concept of the invention. It is understood, therefore, that this invention is not limited to the particular embodiments disclosed, but is intended to cover modifications that are within the spirit and scope of the invention as defined by the claims.

What is claimed is:

1. A composition comprising:
a calcium moiety; and
a sugar alcohol;
wherein the calcium moiety is coated by the sugar alcohol.

2. The composition of claim 1, wherein the calcium moiety is a calcium salt.

3. The composition of claim 2, wherein the calcium salt is selected from the group consisting of calcium carbonate, calcium sulfate, calcium lactate, calcium citrate, and combinations thereof, and further wherein the sugar alcohol is selected from the group consisting of mannitol, sorbitol, xylitol, maltitol, isomalt, erythritol, glycerol, lactitol, hydrogenated starch hydrolysate, and combinations thereof.

4. The composition of claim 1, further comprising water.

5. The composition of claim 4, wherein the composition comprises from about 50% to about 75% of the sugar alcohol by weight, from about 25% to about 45% of the calcium moiety by weight, and from about 1% to about 3% of the water by weight.

6. The composition of claim 1, wherein the composition comprises substantially spherically shaped particles.

7. The composition of claim 1, further comprising a confectionery.

8. The composition of claim 7, wherein the confectionery is selected from the group consisting of a gum composition and chocolate.

9. The composition of claim 6, wherein about 90% by weight of the substantially spherically shaped particles are less than 150 microns in diameter.

10. The composition of claim 6, wherein about 80% by weight of the substantially spherically shaped particles are less than about 75 microns in diameter.

11. A food product comprising the composition of claim 1.

12. A composition for coating a confectionery, consisting essentially of:
a compound including a calcium moiety; and
a sugar alcohol;
wherein the sugar alcohol coats the compound.

13. The composition of claim 12, wherein the composition for coating the confectionery is substantially spherically shaped.

14. The composition of claim 12, wherein the calcium moiety is selected from the group consisting of calcium carbonate, calcium sulfate, calcium lactate, calcium citrate, and combinations thereof, and further wherein the sugar alcohol is selected from the group consisting of mannitol, sorbitol, xylitol, maltitol, isomalt, erythritol, glycerol, lactitol, hydrogenated starch hydrolysate, and combinations thereof.

15. A confectionery coated with the composition of claim 12.

16. A method of making microparticles comprising:
mixing microparticles comprising a calcium moiety with sugar alcohol,
forming a suspension of the microparticles in the sugar alcohol; and
drying the suspension to form discrete microparticles encapsulated with the sugar alcohol.

17. The process according to claim 16, wherein the calcium moiety is selected from the group consisting of calcium carbonate, calcium sulfate, calcium lactate, calcium citrate, and combinations thereof, and further wherein the sugar alcohol is selected from the group consisting of mannitol, sorbitol, xylitol, maltitol, isomalt, erythritol, glycerol, lactitol, hydrogenated starch hydrolysate, and combinations thereof.

18. The process according to claim 17, wherein the microparticles are mixed with the liquid mannitol and water.

19. The process according to claim 16, wherein the drying is selected from the group consisting of spray drying, flash drying, and drum drying.

20. The process according to claim 16, further comprising heating the suspension.
